(19) United States
(12) Patent Application Publication
(10) Pub. No.: US 2011/0266122 A1
(43) Pub. Date: Nov. 3, 2011

(54) OPERATING BUTTONS WITH DISAPPEARING TRIANGULAR INDICIA

(75) Inventors: Walter S. Zaharchuk, Macungie, PA (US); Elliot G. Jacoby, JR., Glenside, PA (US); Nathan Butler, Telford, PA (US); Joel S. Spira, Coopersburg, PA (US)

(73) Assignee: Lutron Electronics Co., Inc.

(21) Appl. No.: 12/771,369

(22) Filed: Apr. 30, 2010

(51) Int. Cl. H01H 9/00

(52) U.S. Cl. 200/308

(57) ABSTRACT

Directional indicators on the control buttons of an electrical control for a light dimmer or a motor controller are formed by triangular lines with vertices pointing away from one another and in a direction related to the change initiated by pressing the related button. The indicia are formed by narrow lines of length less than about one hundred thousands of an inch, and tend to disappear from view as an observer is farther away from the control buttons. The buttons are formed of right triangles with adjacent spaced hypotenuses and fit into a rectangular area. On/off rectangular buttons of the same color as the control buttons are atop and below the rectangular area.

### FIELD OF THE INVENTION

This invention relates to control devices for electrical loads and more specifically relates to control devices in which actuation buttons for driving loads in opposite directions have self-teaching indicators that are clearly visible to an operator only when the operator is close to the actuating buttons.

### DESCRIPTION OF RELATED ART

Hand-held remote control devices and wall mounted control devices are well known for the control of electrical loads such as lamps which are to be controllably dimmed and motors which drive drapes or shades towards open and closed positions. Such control devices usually have operating buttons with indicators of their function such as the dimming direction of a lamp load or the drive direction of a motor. The indications are frequently of large size and of color which contrasts with the surface color of the button. As a result, the indicia are easily observable from all distances from the control. However, the large and often diversely colored indicia impart an undesired cluttered appearance to the device surface.

Such control devices should have an aesthetically pleasing and uncluttered surface appearance while making the function of the control button obvious to the user.

### SUMMARY OF THE INVENTION

In accordance with one aspect of the present invention, there is provided directional indicators for first and second control buttons of an electrical control device for indicating the direction of a change initiated by the actuation of the control button. The first and second control buttons have identical surface areas of the same given color. Each of said first and second buttons receive at least one directional indicator; the directional indicators including at least first and second narrow lines which join at a vertex to define an arrow pointing in a direction related to the direction of change caused by the actuation of its respective button. Each of the narrow lines have a length of less than about 100 mils (i.e., thousands of an inch) whereby the visibility of the lines to the eye is substantially reduced as an observer's distance from the electrical control device is increased.

In accordance with another aspect of the present invention, a combination is provided in which there is an electrical control device having control buttons for controlling the energization of a load; the control buttons including first and second control buttons for initiating the energization of said load in first and second opposite directions respectively, and third and fourth buttons for respectively turning on and off the energization of said load, and directional indicators for the first and second buttons. The first and second buttons are formed in a first rectangular area. The third and fourth buttons are formed in respective rectangular areas on opposite sides of said first rectangular area. Each of the buttons have surface areas of the same color. The first and second buttons receive at least one respective triangular directional indicator for indicating the direction of a change of load energization caused by the actuation of the button. The directional indicators include three sides and point in a direction related to the direction of change caused by the actuation of its respective button. Each of the sides has a length of less than about 100 mils (i.e., thousands of an inch) whereby the visibility of the triangular indicators to the eye is substantially reduced as an observer's distance from the electrical control device is increased.

Preferably the lines have a width of less than about 10 mils (i.e., thousands of an inch) and are formed in a surface of a single color so that they are less visible until an operator approaches the buttons.

The indicator lines in one preferred embodiment are triangles and can indicate increasing or decreasing lamp load lighting in a lighting control device or drape/shade movement direction for a motor controlled window cover.

Still another feature of the invention is to form the indicators in the surface of respective right triangular buttons separated by a narrow gap at their opposite hypotenuse and fitted into a rectangular area. On and off buttons for the load may be positioned above and below, respectively, the rectangular areas. The on/off buttons and the buttons in the rectangular area, except for the indicators and diagonal separation gap, are of a uniform color, for example an all white or a white/gray satin color.

Other features and advantages of the present invention will become apparent from the following description of the invention that refers to the accompanying drawings.

### BRIEF DESCRIPTION OF THE DRAWINGS

FIG. 1 is a perspective view of a first embodiment of a hand-held remote control device of the invention having triangular indicia on control buttons.

FIG. 2 is a side view of the hand-held remote control device of FIG. 1.

FIG. 3 an enlarged view of one of the indicia of the remote control device of FIG. 1.

FIG. 4 is a cross-sectional view taken across the section line A-A in FIG. 3 showing one of the indicia printed on one of the control buttons.

FIG. 5 is a cross-sectional view taken across the section line A-A in FIG. 3 showing one of the indicia etched on one of the control buttons.

FIG. 6 shows the remote control device of FIG. 1 as supported on a pedestal mount.

FIG. 7 shows a side view of the pedestal-mounted remote control device of FIG. 6.

FIG. 8 shows the control device of FIG. 1 mounted in the wall plate of a wall-mounted control device with additional visual indicators.

FIG. 9 is a front view of the control device of FIG. 1 with additional operational indicia for use as a lighting control device.

FIG. 10 shows the control device of FIGS. 1 and 9 with open and close directional indicia for use as a window shade control device.

FIG. 11 shows the control device of FIG. 10 with open and close directional indicia for use as a window drapery control device.

FIGS. 12 and 13 show the control buttons of FIG. 11 having two-line indicia with variations of the shape of the intersecting lines of the indicia.

FIG. 14 shows the control buttons having filled-in triangle indicia according to another embodiment of the invention.

FIG. 15 shows the control buttons having dashed-line triangle indicia according to another embodiment of the invention.

FIG. 16 is a three-dimensional chart showing the relationship between visual angle, contrast, and brightness to determine whether an object can be seen by the human eye.

FIG. 17 is a diagram illustrating a distance x at which an object having a lengthy cannot be viewed for a viewing angle α.

FIG. 18 shows the control buttons having fuzzy indicia according to another embodiment of the invention.

FIG. 19 is an enlarged view of one of the fuzzy indicia of FIG. 18.

FIG. 20 is a plot of the intensity of a leg of the fuzzy indicia of FIG. 18 with respect to the position across the width of the leg.

### DETAILED DESCRIPTION OF THE PREFERRED EMBODIMENTS

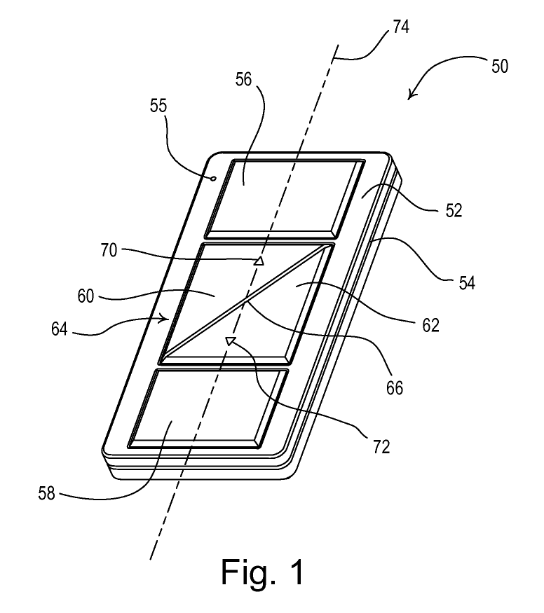

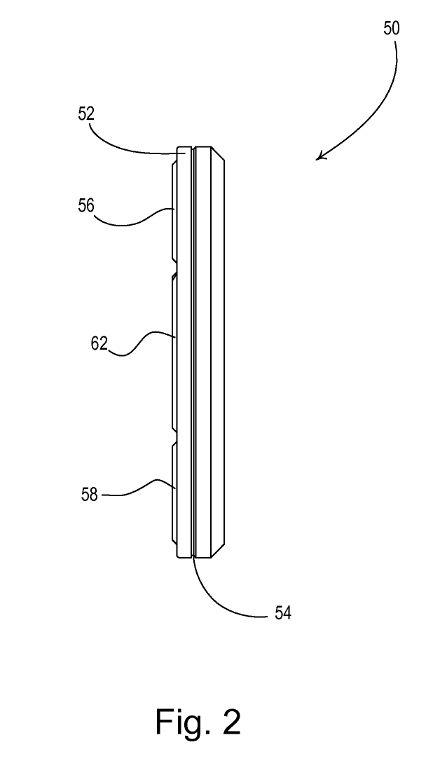

Referring to the drawing Figures in which reference numerals refer to like elements, FIGS. 1 and 2 show a hand-held remote control device 50 for a control system which may be used, for example, for control of the energization of a load, such as a lighting load, a motor load, or the like. The remote control device 50 may have a rectangular plastic body (or bezel) 52 which has a peripheral slot 54 joining two halves of the device which enclose the device electronics and battery (not shown). The remote control device 50 may have a length of about 3 inches, a width of about 1 inch and a thickness about ¼ inch. These are non-critical dimensions. A visual indicator 55 (such as a light-emitting diode) may be placed in body 52 to provide feedback to a user regarding the operation of the remote control device 50. The body 52 receives rectangular on and off control buttons 56, 58 respectively, which may be pressed by an operator to for turning full on and full off the energization of said controlled load, respectively. The rectangular buttons 56, 58 are preferably made of the same plastic and have the same color as that of the body 52.

A pair of right-triangular central control buttons 60, 62 are contained in a rectangular area 64, and may be pressed by the operator to initiate the energization of the controlled load in first and second opposite directions, respectively. The triangular buttons 60, 62 are also preferably of the same material and color as the body 52. The hypotenuses of the triangular buttons 60, 62 face one another and are spaced by a narrow diagonal gap 66 to permit their independent actuation (pressing) by a user. The surface faces of the rectangular buttons 56, 58, 60, 62 are of the same color and lie in a common plane. In a preferred embodiment, the color of the faces of the buttons 56, 58, 60, 62 may be, for example, a white-satin, with the gap 66 appearing as a narrow line (less than about 10 thousands of an inch wide) separating the triangular buttons 60, 62.

In order to immediately convey the function of the triangular buttons 60, 62 to a user, respective up and down indicia 70, 72 (i.e., indicators) are formed in the triangular buttons 60, 62, respectively. The indicia 70, 72 each include at least two lines (i.e., legs or sides) joined at a vertex with the vertices pointing in opposite directions. The indicia 70, 72 indicators are both aligned along a central line 74 through the rectangular area 64 where the central line is parallel to two opposite sides of the rectangular area. As shown in FIG. 1, the indicia are isosceles triangles with the upper vertex of the triangular indicium 70 pointing upward and the lower vertex of the triangular indicium 72 pointing in an opposite direction (i.e., downward). The indicia 70, 72 indicate the direction of change of the energization of the controlled load caused by the actuation of the respective triangular buttons 60, 62.

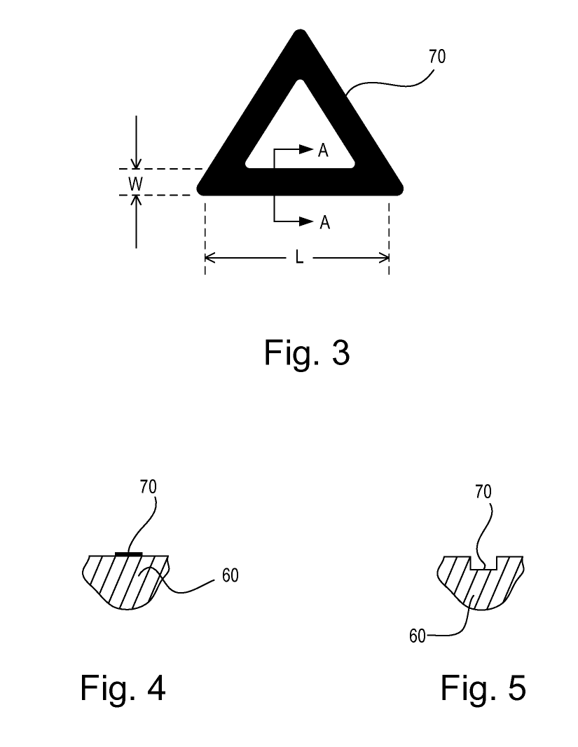

FIG. 3 is an enlarged view of the up indicium 70, the down indicium 72 having the same dimensions and being a mirror image of the up indicium. The sides of the triangular indicia 70, 72 may be formed by preferably printing (i.e., painting) lines on the triangular buttons 60, 62. FIG. 4 is a cross-sectional view taken across the section line A-A in FIG. 3 showing the up indicium 70 printed on the triangular button 60. Alternatively, the sides of the triangular indicia 70 and 72 may be formed by etching (i.e., engraving or embossing) lines on the triangular buttons 60, 62. FIG. 5 is a cross-sectional view taken across the section line A-A in FIG. 3 showing the up indicium 70 etched on the triangular button 60.

The lines of the triangular indicia 70, 72 each have a line width W less than about 10 mils (i.e., thousands of an inch), such that, at a distance from control device 50, the indicia blend into the color of the button surface, and become virtually invisible to the eye of the user so that a very uncluttered and aesthetically pleasing surface is visible to the casual observer or occupant of the space containing the control device 50. However, as a user approaches the control device 50 to actuate one of the buttons 56, 58, 60, 62, the triangular indicia 70, 72 come plainly in view.

Each of the legs of the triangular indicia 70, 72 have a line length L that is less than about 100 mils, and preferably about 70 mils, such that the effect of reduced visibility at a distance from the control device 50 is enhanced. Accordingly, the triangular indicia 70, 72 will tend to disappear from view to the user when the user is positioned away from the control device 50 and becomes visible as the user gets closer to the control device. While the dimensions of the legs of the triangular indicia 70, 72 help to ensure that the indicia cannot be seen from a position away from the control device 50, the number of legs of each of the indicia (i.e., three legs) allow the indicia to be seen more easily as the user approaches the control device.

Preferably, the ink (or the paint) of the indicia 70, 72 is the same texture as the surface of the triangular buttons 60, 62. For example, the indicia 70, 72 and the triangular buttons 60, 62 may both have a gloss finish. The reflectivity of the gloss surfaces of the indicia 70, 72 and the triangular buttons 60, 62 will reflect ambient light sources and cause the indicia 70, 72 to be less visible at a distance from the control device 50. Alternatively, the indicia 70, 72 and the triangular buttons 60, 62 may both have a matte finish. In addition, the contrast (i.e., ratio between the intensity of the ink or the paint of the indicia 70, 72 and the respective triangular buttons 60, 62) may be decreased in order to make the indicia less visible at a distance from the control device 50. Preferably, the indicia 70, 72 have a low contrast (e.g., less than or equal to approximately 40%).

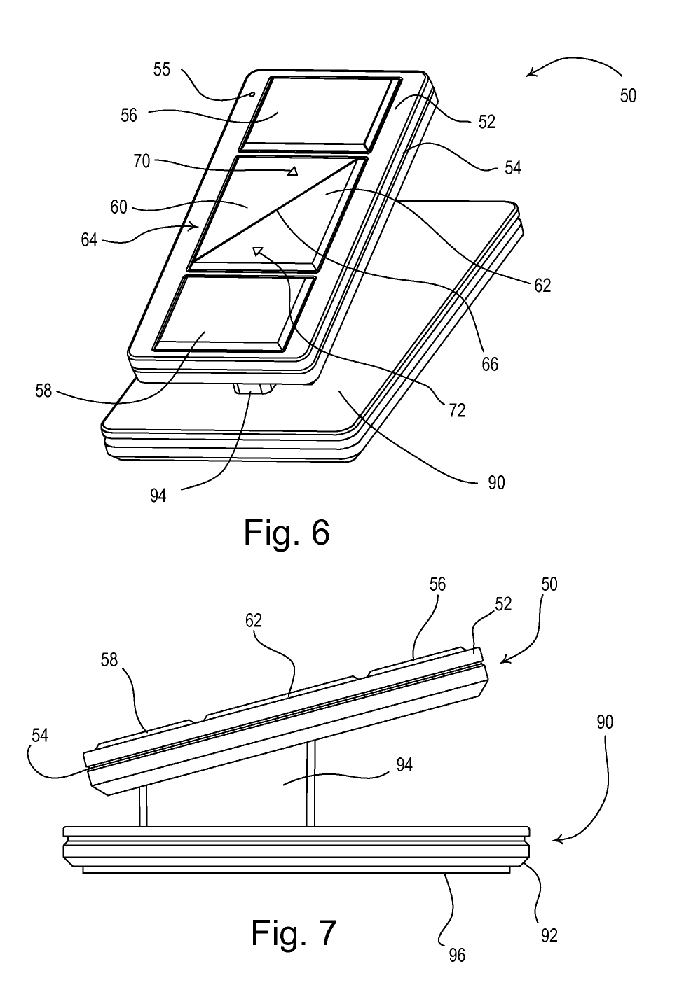

According to an alternate embodiment of the invention, the remote control device 50 may also be supported in a plastic pedestal mount as shown in FIGS. 6 and 7. The pedestal 90 has a flat bottom section 92 which has a perpendicular web 94, which has an enlarged head (not shown) that removably slides into a slot (not shown) in the back of body 50. A rubber-like non-skid pad 96 may be added to the bottom section 92.

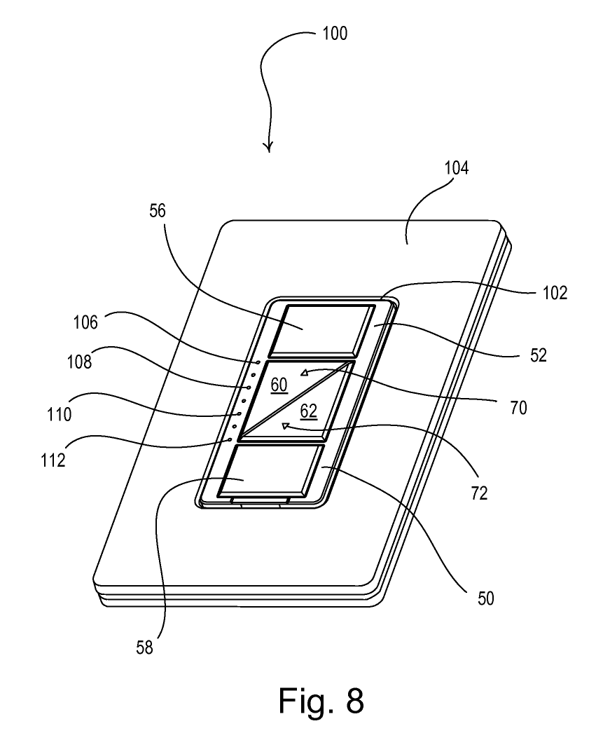

In another embodiment of the invention, and as shown in FIG. 8, a wall-mounted control device 100 may employ the structure of the remote control device 50 of FIGS. 1 and 2, where the remote control device is fixed within an opening 102 of a wall plate 104. In the embodiment of FIG. 6, a line of visual indicators 106 to 112 (i.e., light-emitting diodes) may also be formed in the body 52 to indicate the status of the controlled load.

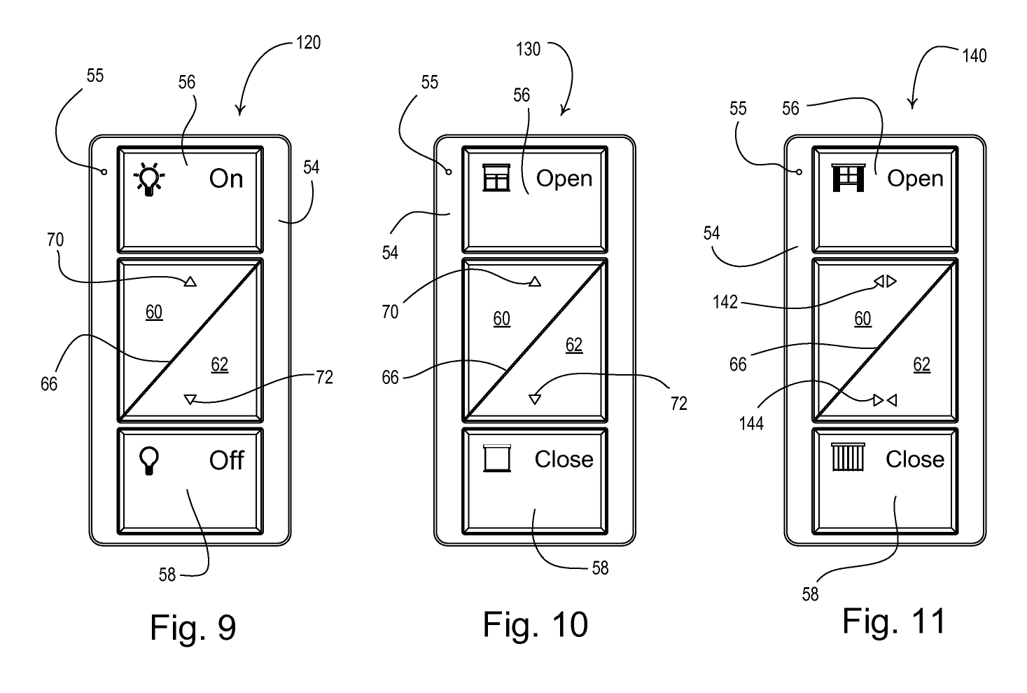

FIG. 9 shows the application of the invention used on a lighting control device 120, which allows for control of a lighting load and employs the structure of the remote control device 50 of FIGS. 1 and 2. Thus, in the lighting control device 120, the rectangular buttons 56, 58 are lamp on and off buttons, respectively, while the triangular buttons 60, 62 are dim-up and dim-down buttons, respectively.

FIG. 10 shows a window shade control device 130, which has the structure of the remote control device 50 shown in FIGS. 1, 2 and 9, but allows for control of a motorized roller shade. The rectangular buttons 56, 58 of the window shade control device 130 provide full open and full close controls respectively for the controlled motorized roller shade. The triangular buttons 60, 62 of the window shade control device 130 provide move-up and move-down controls respectively, which operate so long as the buttons are depressed.

FIG. 11 shows a window drapery control device 140 for opening and controlling motorized draperies, which are formed in halves and move horizontally towards and away from one another to close and open respectively the drapery fabric. The rectangular buttons 56, 58 are full-open and full-close controls, while the triangular buttons 60, 62 are cause the draperies to move towards open and to move towards close as long as the buttons are depressed. In the embodiment of FIG. 11, indicia 142 and 144 replace indicia 70 and 72 and are respectively defined by triangular indicia with vertices pointing away from one another (to indicate opening) and towards one another (to indicate closing).

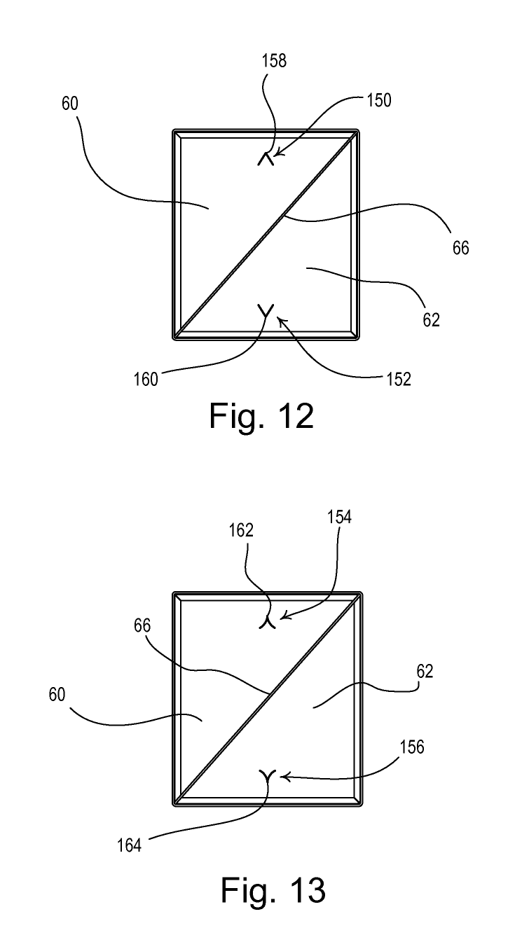

FIGS. 12 and 13 show the rectangular buttons 60, 62 with the triangular indicia 70, 72 of the preceding Figs. replaced by indicia 150, 152 (FIG. 12) or 154, 156 (FIG. 13). Each of these indicia 150, 152, 154, 156 consists of only two legs (i.e., lines) joined to vertices 158, 160, 162, 164 respectively to thus define directional arrows or pointers. The vertices of the indicia 150, 152, 154, 156 point in opposite directions. The legs of each of the indicia 150, 152 shown in FIG. 12 are straight, whereas the legs of each of the indicia 154, 156 shown in FIG. 13 are slightly curved. The two legs of each of the indicia 150, 152 shown in FIG. 12 are at an angle to one another greater than about 30° to define a pointer. Since each of these indicia 150, 152, 154, 156 only has two legs, the indicia are even harder to see than the three-sided triangular indicia 70, 72 of the first embodiment when viewed at a distance from the control device 50.

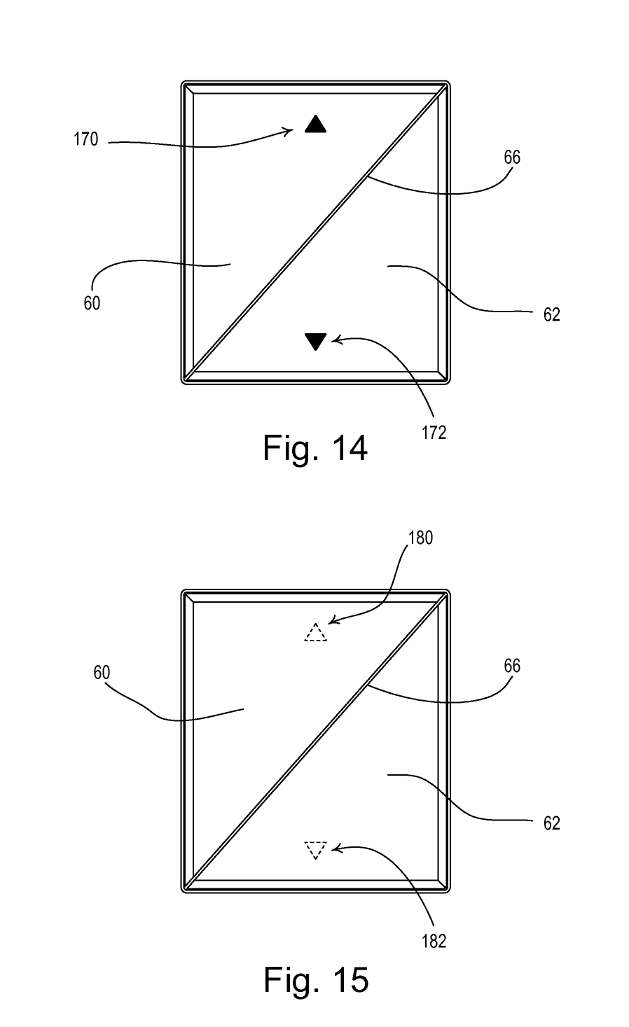

FIG. 14 shows the rectangular buttons 60, 62 having filled-in triangle indicia 170, 172 according to an alternate embodiment of the invention. The area between the three legs of the filled-in triangle indicia 170, 172 is preferably painted the same color as the color legs, such that the indicia appear as solid triangles. Accordingly, the filled-in triangle indicia 170, 172 will be easier to see at a distance from the remote control 50. However, the contrast (i.e., ratio between the intensity of the ink or the paint of the filled-in triangle indicia 170, 172 and the respective triangular buttons 60, 62) may be decreased in order to make the indicia less visible at a distance from the control device 50.

FIG. 15 shows the rectangular buttons 60, 62 having dashed-line triangle indicia 180, 182 according to another embodiment of the invention. The dashed-line triangle indicia 180, 182 comprise legs, which are each formed by a number of linearly-arranged segments. The gaps between the segments of the dashed lines of the dashed-line triangle indicia 180, 182 enhance the effect of reduced visibility when the control device 50 is viewed at a distance, but allow the indicia to be seen when viewed from up close. The specific length of the segments determines the distance from the control device 50 at which the dashed-line triangle indicia 180, 182 can no longer be seen by the human eye, which is ultimately determined by the resolving power of the human eye. The resolving power is the ability of the human eye to determine the angular separation of the points of an object, for example, the endpoints of one of the line segments of the dashed-line triangle indicia 180, 182. In addition, the contrast (i.e., ratio between the intensity of the dashed-line triangle indicia 180, 182 and the respective triangular buttons 60, 62) and the brightness of the space in which the remote control 50 is viewed also affect whether the dashed-line triangle indicia 180, 182 can be viewed.

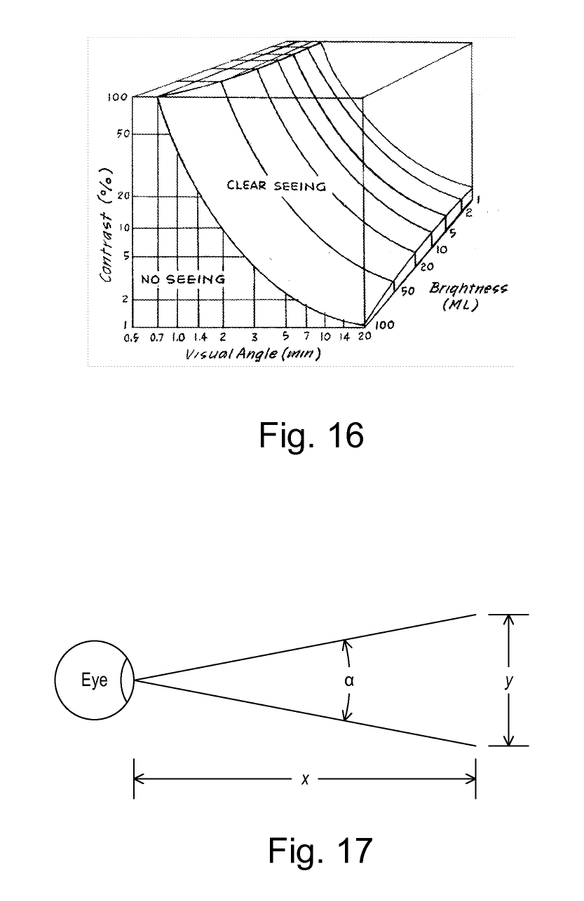

FIG. 16 is a three-dimensional chart showing the relationship between a visual angle α (i.e., the angular separation of an object), the contrast, and the brightness to determine whether the object can be seen by the human eye (WOODSON, WESLEY E., Human Factors Design Handbook, 1981, p. 825, McGraw-Hill, Inc.). For example, assuming a contrast of 40% and a brightness of 0.1 lamberts, the human eye cannot see an object if the viewing angle α (i.e., the angular separation of the object) is less than one minute (i.e., approximately 0.0167°). The viewing angle α can be used to determine a maximum lengthy of an object that cannot be seen by the human eye at a distance x from the object (as shown in FIG. 17), i.e.,

y=2·x·tan(α/2).

Using the above equation as well as the chart shown in FIG. 16, the following table of viewing distances x and object lengths y may be determined for different contrasts.

TABLE 1
Example values for the length y of an object that cannot be seen at a
viewing distance x

Object Length y

| Viewing Distance x | Contrast = 40% | Contrast = 10% |
|---|---|---|
| 1″ | 0.0003″ | 0.0006″ |
| 10″ | 0.003″ | 0.006″ |
| 20″ | 0.006″ | 0.012″ |
| 30″ | 0.009″ | 0.018″ |
| 40″ | 0.012″ | 0.024″ |

Accordingly, the dashed-line triangle indicia 180, 182 cannot be seen by the human eye at a distance of 30 inches if the contrast is 40% and the lengths of the segments are less than 0.009 inches, or if the contrast is 10% and the lengths of the segments are less than 0.018 inches.

The line widths W of the legs of the dashed-line triangle indicia 180, 182 should be less than or equal to the lengths of the segments. In addition, the gaps between two adjacent segments of the dashed line triangle indicia 180, 182 should be greater than or equal to the lengths of the segments. Alternatively, the dashed-line triangle indicia 180, 182 could comprise dotted-line triangle indicia formed from square segments having equal lengths and widths or from circle segments.

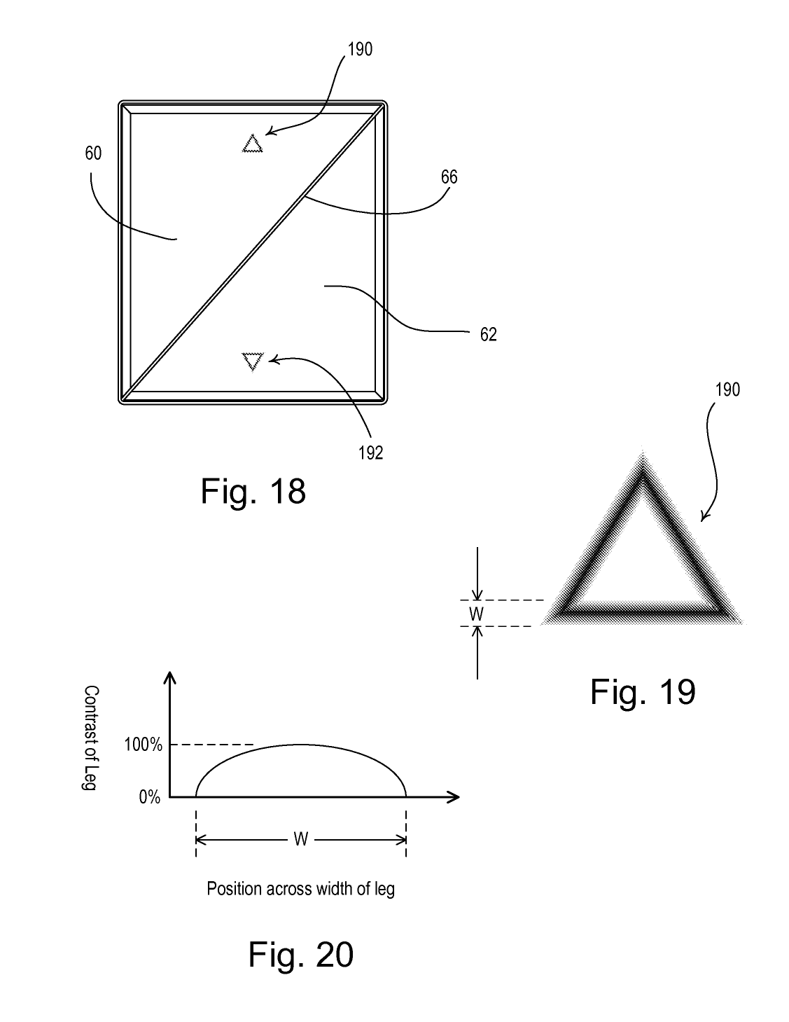

FIG. 18 shows the triangular buttons 60, 62 having fuzzy indicia 190, 192 according to another embodiment of the invention. FIG. 19 is an enlarged view of the up indicium 190, where the down indicium 192 is a mirror image of the up indicium. The intensity of each of the legs of the fuzzy indicia 190, 192 (i.e., the contrast with respect to the triangular buttons 60, 62) changes across the width of the respective leg (e.g., as a gradient). FIG. 20 is a plot of the intensity of one of the legs of the fuzzy indicia 190, 192 with respect to the position across the width of the leg. For example, the intensity of the leg may be at a maximum value (e.g., 100%) near the middle of the leg, while the intensity may approach a minimum value (e.g., 0%) near the edges of the leg.

When an object has a sharp edge that forms a boundary between regions of different intensities (i.e., high contrast), the intensity of the object as perceived by the human eye may increase or decrease near the boundary. This illusion is known as the Mach effect (WILLIAMSON, SAMUEL J., Light and Color in Nature and Art, 1983, pp. 326-327, John Wiley & Sons). Since the contrast of each of the legs of the indicia 70, 72 of the first embodiment are constant across the width of the leg, the human eye may perceive a greater intensity near the edges of the indicia 70, 72 (i.e., the edges are pronounced). Therefore, according to the embodiment of FIGS. 18-20, the contrast of each of the legs of the fuzzy indicia 190, 192 decreases near the edges in order to counter the Mach effect. Thus, the ability of a user to view the fuzzy indicia 190, 192 at a distance from the control device 50 is reduced. However, the greater intensity of the fuzzy indicia 190, 192 near the centers of the legs allow the fuzzy indicia 190, 192 to be viewed easily from up close.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. Directional indicators for the first and second control buttons of an electrical control device for indicating the direction of a change initiated by the actuation of either control button; said first and second control buttons having identical surface areas of the same color; each of said first and second buttons receiving at least one directional indicator; said directional indicators including at least first and second narrow lines which join at a vertex to define an arrow pointing in a direction related to the direction of change caused by the actuation of its respective button; each of said lines having a length of less than about 100 thousandths of an inch whereby the visibility of said lines to the eye is substantially reduced as an observer's distance from the electrical control device is increased.

2. The directional indicator of claim 1, wherein said first and second lines have a width less than about 10 thousandths of an inch.

3. The directional indicator of claim 2, wherein said first and second lines are at an angle to one another greater than 30°.

4. The directional indicators of claim 3, wherein said lines are two of the sides of respective isosceles triangles.

5. The directional indicators of claim 1, wherein each of said lines has a length of about 70 thousandths of an inch.

6. The directional indicators of claim 1, wherein said vertices point in opposite directions.

7. The directional indicators of claim 1, wherein said lines are printed onto the surface of their respective buttons.

8. The directional indicators of claim 1, wherein said lines are etched lines formed into the surface of their respective buttons.

9. The directional indicators of claim 1, wherein said indicators are up and down indicators respectively.

10. The directional indicators of claim 1, wherein said indicators are side-to-side indicators respectively.

11. The directional indicators of claim 1, wherein said buttons are formed in a rectangular area and are separated by a diagonal extending across said rectangular area, said indicators being aligned with one another along a central line through said rectangular area in which the central line is parallel to two opposite sides of said rectangular area.

12. The directional indicators of claim 1, wherein each of said lines comprises a dashed line formed from a plurality of line segments.

13. The directional indicators of claim 1, wherein each of said lines comprises a dotted line.

14. The directional indicators of claim 1, wherein each of said lines comprises a fuzzy line.

15. In combination; an electrical control device having control buttons for controlling the energization of a load; said control buttons including first and second control buttons for initiating the energization of said load in first and second opposite directions respectively, and third and fourth buttons for respectively turning full on and full off the energization of said load; and directional indicators for said first and second buttons; said first and second buttons being formed in a first rectangular area; said third and fourth buttons being formed in respective rectangular areas on opposite sides of said first rectangular area; each of said buttons having surface areas of the same color; each of said first and second buttons receiving at least one respective triangular directional indicator for indicating the direction of a change of energization caused by the actuation of the button; said directional indicators including three sides and pointing in a direction related to the direction of change caused by the actuation of its respective button; each of said sides having a length of less than about 100 thousandths of an inch whereby the visibility of said triangular indicators to the eye is substantially reduced as an observer's distance from the electrical control device is increased.

16. The combination of claim 15, wherein said first and second buttons are separated by a diagonal extending across said first rectangular area; said indicators on said first and second buttons being aligned along a central line through said rectangular areas and parallel to the opposite sides of said first rectangular area.

17. The combination of claim 15, each of said sides comprises a line having a length of about 70 thousandths of an inch.

18. The combination of claim 15, wherein each of said sides comprises a line having a width less than about 10 thousandths of an inch.

19. The combination of claim 15, wherein said triangular indicators are printed onto the surface of their respective buttons.

20. The combination of claim 15, wherein said triangular indicators are etched into the surface of their respective buttons.

21. The combination of claim 15, wherein said triangular indicators are up and down indicators respectively.

22. The combination of claim 15, wherein said triangular indicators are side-to-side indicators respectively.

23. The combination of claim 15, wherein said triangular indicators are isosceles triangles.

24. The combination of claim 15, wherein each of said sides comprises a dashed line formed from a plurality of line segments.

25. The combination of claim 15, wherein each of said sides comprises a dotted line.

26. The combination of claim 15, wherein each of said sides comprises a fuzzy line.
